(19) United States
(12) Patent Application Publication
(10) Pub. No.: US 2025/0210775 A1
(43) Pub. Date: Jun. 26, 2025

(54) PRESSURIZING APPARATUS FOR BATTERY TRAY

(71) Applicant: CHROMA ATE INC., Taoyuan City (TW)

(72) Inventors: Yi-Sheng Hsu, Taoyuan City (TW); Chao-Cheng Wu, Taoyuan City (TW); Chia-Hung Lai, Taoyuan City (TW)

(73) Assignee: CHROMA ATE INC., Taoyuan City (TW)

(21) Appl. No.: 18/809,714

(22) Filed: Aug. 20, 2024

(30) Foreign Application Priority Data
Dec. 26, 2023 (TW) 112150881

(51) Int. Cl. H01M 50/244

(52) U.S. Cl. CPC H01M 50/244

(57) ABSTRACT

A pressurizing apparatus for a battery tray is provided. The pressurizing apparatus includes a base, a compressive force generation module, a fixing module, and a controller. The compressive force generation module and the fixing module are arranged on the base. The controller is electrically connected to the compressive force generation module and the fixing module. The controller is configured to control the fixing module to be coupled between the compressive force generation module and the battery tray. The controller is configured to control the compressive force generation module to apply a compressive force to a pressure-bearing plate of the battery tray, so that the pressure-bearing plate pressurizes a pressurizing plate of the battery tray, thereby forming a containment on the batteries on a plurality of partition plates of the battery tray.

### CROSS-REFERENCE TO RELATED APPLICATION

This non-provisional application claims priority under 35 U.S.C. § 119 (a) to patent application No. 112150881 filed in Taiwan, R.O.C. on Dec. 26, 2023, the entire contents of which are hereby incorporated by reference.

### BACKGROUND

### Technical Field

The present disclosure relates to battery formation technologies, and particularly relates to a pressurizing apparatus adapted to pressurize a battery tray to form a containment on batteries into shape.

### Related Art

Generally, a formation process would have to be applied to semi-products of lithium batteries (i.e., soft-packed lithium batteries), and then the finished products can be manufactured, in which the term “formation” refers to a process of energizing the soft-packed lithium batteries to make chemical components in a fluid state in the soft-packed lithium batteries be solidified gradually, so that the soft-backed lithium batteries can store electrical energy properly. However, in the soft-packed lithium batteries, the chemical components in the fluid state are filled in a flexible bag, the soft-packed lithium batteries gradually expand during the formation process. Therefore, how to avoid excessive expansion of the soft-packed lithium batteries has become one of the issues that needs to be solved during the formation process.

### SUMMARY

In order to address the issue(s) mentioned above, the inventors provide a pressurizing apparatus for a battery tray. The pressurizing apparatus is configured to provide a uniform external force to pressurize and shape the soft-packed lithium batteries, thereby preventing the soft-packed lithium batteries from expanding during the formation process. In some embodiments, the battery tray comprises a frame, a pressurizing plate, a pressure-bearing plate, a plurality of partition plates, and at least one spring. The pressurizing plate, the pressure-bearing plate, and the plurality of partition plates are coupled to the frame, the at least one spring is arranged between the pressurizing plate and the pressure-bearing plate, and at least one battery is arranged on each of the plurality of partition plates. The pressurizing apparatus comprises a base, a compressive force generation module, a fixing module, and a controller. The compressive force generation module is arranged on the base, and the fixing module is arranged on the base. The controller is electrically connected to the compressive force generation module and the fixing module. The controller is configured to control the fixing module to be coupled between the compressive force generation module and the frame of the battery tray, and the controller is configured to control the compressive force generation module to apply a compressive force to the pressure-bearing plate of the battery tray, so that the pressure-bearing plate presses the pressurizing plate through the at least one spring, thereby forming a containment on the at least one battery on each of the plurality of partition plates.

In some embodiments, the compressive force generation module comprises a mounting base and a thrust generator. The mounting base is coupled to the base. The thrust generator is arranged on the mounting base. The frame comprises a fixing plate, and the fixing plate comprises at least one locking arm. In response to that the controller controls the fixing module to be coupled between the compressive force generation module and the frame, one of two ends of the at least one locking arm is engaged with the mounting base, and the other end of the at least one locking arm is engaged with the fixing plate.

In some embodiments, the compressive force generation module further comprises a displacement generation unit and a guide rail. The displacement generation unit is arranged on the base, and the guide rail is arranged on the base. The mounting base is coupled to the guide rail, and the displacement generation unit is electrically connected to the controller and is controlled to drive the mounting base to slide.

In some embodiments, the fixing module further comprises an actuator, and the actuator is coupled to the base and electrically connected to the controller. The at least one locking arm is coupled to the actuator, and the controller is further configured to control the actuator to make the at least one locking arm move close to or away from the mounting base and the fixing plate.

In some embodiments, the fixing module further comprises a first sliding member and a second sliding member. The first sliding member is coupled to the at least one locking arm, and the at least one locking arm slides along a first direction through the first sliding member. The second sliding member is arranged between the first sliding member and the base and coupled to the actuator, and the at least one locking arm slides along a second direction through the second sliding member.

In some embodiments, the fixing module further comprises a bearing plate and an elastic member. The bearing plate is arranged between the first sliding member and the second sliding member, in which the actuator comprises a moveable portion, and the moveable portion is coupled to the bearing plate. Each of the at least one locking arm comprises a stopping portion, and the elastic member is arranged between the bearing plate and the stopping portion.

In some embodiments, the compressive force generation module comprises a mounting base and a thrust generator. The mounting base is arranged on the base. The thrust generator is arranged on the mounting base. The frame comprises a fixing plate, the fixing plate comprises at least one locking arm, and one of two ends of the at least one locking arm is hinged with the mounting base. In response to that the controller controls the fixing module to be coupled between the compressive force generation module and the frame, the other end of the at least one locking arm is engaged with the fixing plate.

In some embodiments, the fixing module further comprises an actuator, a first sliding member, and a second sliding member. The actuator is arranged on the base and electrically connected to the controller. The first sliding member is coupled to the at least one locking arm. The second sliding member is arranged between the first sliding member and the base and coupled to the actuator. In response to that the controller controls the actuator to drive the other end of the at least one locking arm to move close to or away from the mounting base and the fixing plate, the at least one locking arm slides along a first direction through the first sliding member, and the at least one locking arm slides along a second direction through the second sliding member. In some embodiments, the fixing module further comprises a pivoting member. The pivoting member is arranged between the first sliding member and the second sliding member, and the first sliding member and the second sliding member are pivotally rotated with respect to each other through the pivoting member.

In some other embodiments, a pressurizing apparatus for a battery tray comprises a base, a compressive force generation module, a fixing module, and a controller. The compressive force generation module comprises a thrust generator and a mounting base, wherein the mounting base is coupled to the base, and the thrust generator is arranged on the mounting base. The fixing module comprises a pair of actuators and a pair of locking arms, wherein the pair of actuators are arranged on the base, and the pair of locking arms are respectively coupled to the pair of actuators and arranged on two side of the compressive force generation module and two side of the battery tray. The controller is electrically connected to the thrust generator and the pair of actuators, wherein the controller is configured to control the pair of actuators to drive the pair of locking arms to be respectively coupled between mounting base and the battery tray, thereby maintaining a distance between the compressive force generation module and the battery tray within a specific range, and the controller is configured to control the thrust generator to apply a compressive force to the battery tray.

In conclusion, according to one or some of the above embodiments, the pressurizing apparatus for the battery tray can apply the compressive force to the battery tray, so that the battery arranged on each of the plurality of partition plates of the battery tray can be pressurized and shaped through the compressive force generation module. Under the configuration that one of two ends of the at least one locking arm is engaged with the mounting base and the other end of the at least one locking arm is engaged with the fixing plate, upon the battery tray bears the compression force, the battery tray can be prevented from having displacement which would cause the compressive force generation module from applying the compressive force to the battery tray properly and thus making the battery be pressurized and shaped inefficiently.

### BRIEF DESCRIPTION OF DRAWINGS

The instant disclosure will become more fully understood from the detailed description given herein below for illustration only, and therefore not limitative of the instant disclosure, wherein:

FIG. 1 illustrates a module block diagram of an embodiment of a pressurizing apparatus;

FIG. 2 illustrates a perspective view of an embodiment of a pressurizing apparatus and a battery tray, in which the battery tray has not moved to a pressurized position;

FIG. 3 illustrates a perspective view of a battery tray in a pressurized state;

FIG. 4 illustrates a top view of a battery tray in a pressurized state, in which a spacing maintenance device is omitted;

FIG. 5 illustrates a perspective view of a first embodiment of a pressurizing apparatus;

FIG. 6 illustrates a front view of an embodiment of the compressive force generation module in FIG. 5;

FIG. 7 illustrates a perspective view of an embodiment of the fixing module in FIG. 5;

FIG. 8 illustrates an exploded view of an embodiment of the fixing module in FIG. 5;

FIG. 9 illustrates a perspective view of a second embodiment of a pressurizing apparatus;

FIG. 10 illustrates a front view of an embodiment of the compressive force generation module in FIG. 9;

FIG. 11 illustrates a perspective view of an embodiment of the fixing module in FIG. 9; and

FIG. 12 illustrates an exploded view of an embodiment of the fixing module in FIG. 9.

### DETAILED DESCRIPTION

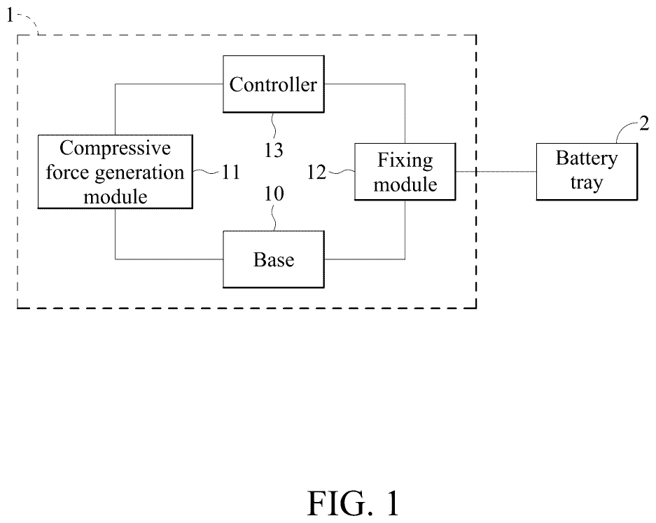

Please refer to FIG. 1 to FIG. 4. A pressurizing apparatus 1 and a battery tray 2 are shown in the figures. The pressurizing apparatus 1 comprises a base 10, a compressive force generation module 11, a fixing module 12, and a controller 13. The compressive force generation module 11 and the fixing module 12 are arranged on the base 10, and the controller 13 is electrically connected to the compressive force generation module 11 and the fixing module 12.

In some embodiments, the battery tray 2 comprises a frame 20, a pressurizing plate 21, a pressure-bearing plate 22, a plurality of partition plates 23, and four springs 24. The pressurizing plate 21, the pressure-bearing plate 22, and the plurality of partition plates 23 are coupled to the frame 20, so that the pressurizing plate 21, the pressure-bearing plate 22, and the plurality of partition plates 23 are movable with respect to the frame 20. The springs 24 are arranged between the pressurizing plate 21 and the pressure-bearing plate 22. In some embodiments, the battery tray 2 is configured to load soft-packed lithium batteries; that is, a soft-packed lithium battery (not shown) is fixed on each of two sides of each of the plurality of partition plates 23, and the frame 20 comprises a fixing plate 200.

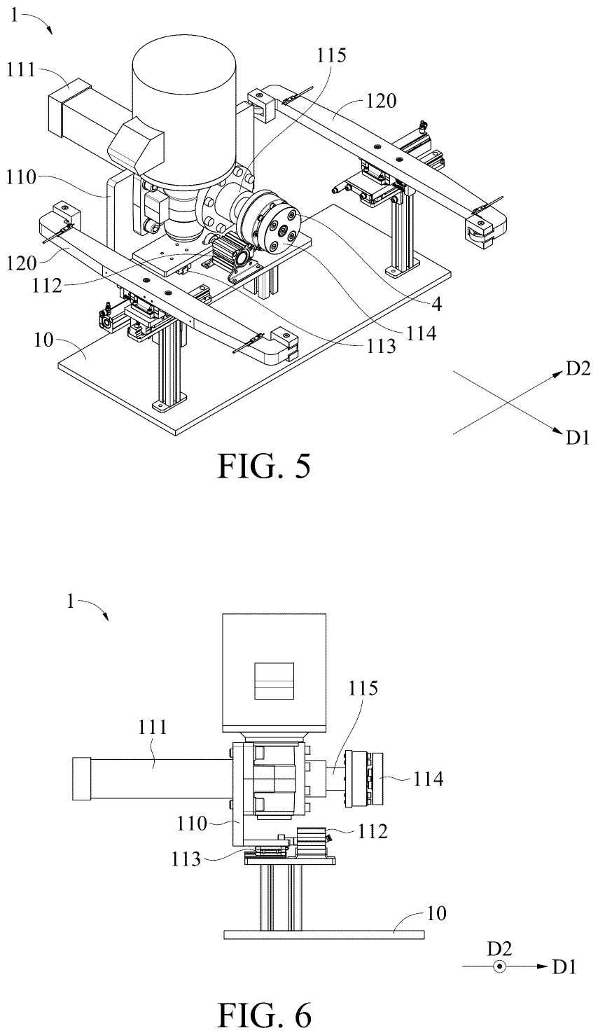

Please refer to FIG. 1 to FIG. 8, in which FIG. 5 to FIG. 8 illustrate implementations of a first embodiment of the pressurizing apparatus 1 for the battery tray 2. As shown in FIG. 5 to FIG. 8, in the present embodiment, the compressive force generation module 11 of the pressurizing apparatus 1 for the battery tray 2 comprises a mounting base 110 and a thrust generator 111. The mounting base 110 is coupled to the base 10, and the thrust generator 111 is arranged on the mounting base 110. In some embodiments, the fixing module 12 comprises a pair of locking arms 120, while the present disclosure is not limited thereto. The fixing module 12 may comprise a single or a plurality of locking arms 120.

In the present embodiment, in response to that the pressurizing apparatus 1 for the battery tray 2 starts to operate, the controller 13 controls the fixing module 12 to be coupled between the compressive force generation module 11 and the frame 20 of the battery tray 2. In some embodiments, the fixing module 12 is coupled between the compressive force generation module 11 and the frame 20 of the battery tray 2 by configuring one of two ends of each of the pair of locking arms 120 to be engaged with the mounting base 110 and the other end of each of the pair of locking arms 120 to be engaged with the fixing plate 200.

In some embodiments, the fixing module 12 further comprises a pair of actuators 121, and the pair of actuators 121 are coupled to the base 10 and electrically connected to the controller 13. The pair of actuators 121 are respectively coupled to the corresponding locking arm 120, and the controller 13 controls the pair of actuators 121 of the fixing module 12 to drive the pair of locking arms 120 to move close to or away from the mounting base 110 and the fixing plate 200. In some embodiments, in response to that the controller 13 controls the fixing module 12 to be coupled between the compressive force generation module 11 and the frame 20, the controller 13 controls the pair of actuators 121 to drive the pair of locking arms 120 to move close to the mounting base 110 and the fixing plate 200, so that one of two ends of each of the pair of locking arms 120 is engaged with the mounting base 110 and the other end of each of the pair of locking arms 120 is engaged with the fixing plate 200.

In some embodiments, the fixing module 12 further comprises a first sliding member 122 and a second sliding member 123. The first sliding member 122 is coupled to the pair of locking arms 120, and the second sliding member 123 is arranged between the first sliding member 122 and the base 10 and coupled to the pair of actuators 121. In some embodiments, the pair of locking arms 120 can slide along a first direction D1 through the first sliding member 122. In addition, in response to that the pair of actuators 121 are activated, the pair of locking arms 120 can move along a second direction D2 through the second sliding member 123.

In some embodiments, in response to that the fixing module 12 is arranged between the compressive force generation module 11 and the frame 20, the controller 13 controls the compressive force generation module 11 to apply a compressive force to the pressure-bearing plate 22 of the battery tray 2 to make the pressure-bearing plate 22 press the pressurizing plate 21 through the four springs 24, thereby forming a containment on the at least one battery on each of the plurality of partition plates 23.

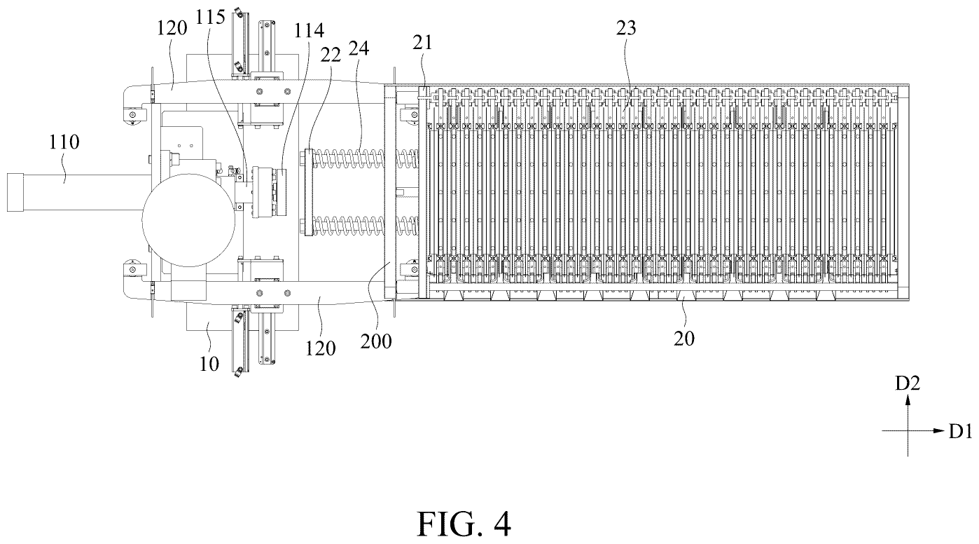

Specifically, in some embodiments, the compressive force generation module 11 applies the compressive force to the pressure-bearing plate 22 of the battery tray 2 using the thrust generator 111. One of two ends of the thrust generator 11 has a pressurizing head 114 and a telescopic member 115, and the pressurizing head 114 faces the first direction D1 and one side surface of the pressure-bearing plate 22 of the battery tray 2 (as shown in FIG. 4). In some embodiments, in response to that the compressive force generation module 11 applies the compressive force to the pressure-bearing plate 22 of the battery tray 2, the telescopic member 115 of the compressive force generation module 11 extends to make the pressurizing head 114 contact the pressure-bearing plate 22 and gradually apply the compressive force to the pressure-bearing plate 22. After that, the battery tray 2 is slightly moved away from the direction of the pressurizing head 114 (the first direction D1), so that one of two ends of the pair of locking arms 120 is tightly engaged with the fixing board 200.

In some embodiments, in response to that the battery tray 2 is slightly moved away from the direction of the pressurizing head 114 (the first direction D1), the pair of locking arms 120 may be driven by the fixing plate 200. Therefore, the pair of locking arms 120 slide along the first direction D1 through the first sliding member 122, so that the other end of the pair of locking arms 120 is tightly engaged with the mounting base 110. At this moment, since one of two ends of the pair of locking arms 120 is engaged with the fixing plate 200 and the other end of the pair of locking arms 120 is engaged with the mounting base 110, the distance between the compressive force generation module 11 and the battery tray 2 is maintained within a specific range which is a length of the pair of locking arms 120 in the first direction D1. Therefore, in response to that the compressive force generation module 11 continues to apply the compressive force to the battery tray 2, the battery tray 2 will no longer be moved, thereby facilitating the continuous application of the compressive force.

In some embodiments, in response to that the compressive force generation module 11 applies the compressive force to the pressure-bearing plate 22, the pressure-bearing plate 22 transmits the compressive force to the pressurizing plate 21 through the four springs 24, so that the pressurizing plate 21 pressurizes and shapes the batteries (not shown) arranged on the plurality of partition plates 23. In some embodiments, before the compressive force generation module 11 applies the compressive force to the battery tray 2, the four springs 24 can apply the compressive force to the pressurizing plate 21 in advance to make the plurality of partition plates 23 be closely attached with each other and make the batteries be shaped slightly. In addition, the four springs 24 can provide a buffering effect to prevent the pressurizing head 114 from directly impacting the pressurizing plate 21 and prevent the compressive force generation module 11 from exerting excessive force.

In some embodiments, in response to that the formation process for the batteries is finished, the operation of the pressurizing apparatus 1 for the battery tray 2 is stopped, and the controller 13 controls the pair of actuators 121 to drive the pair of locking arms 120 to move away from the mounting base 110 and the fixing plate 200. In some embodiments, the pair of locking arms 120 can slide along the second direction D2 through the second sliding member 123, thereby making the pair of locking arms 120 move away from mounting base 110 and the fixing plate 200 to ensure that the pair of locking arms 120 do not continue to be engaged with the mounting base 110 and the fixing plate 200.

As shown in FIG. 5 and FIG. 6, the compressive force generation module 11 further comprises a displacement generation unit 112 and a guide rail 113. The displacement generation unit 112 and the guide rail 113 are arranged on the base 10, and the mounting base 110 is coupled to the guide rail 113. In some embodiments, the displacement generation unit 112 is electrically connected to the controller 13 and is controlled to drive the mounting base 110 to slide. In some embodiments, in response to that the compressive force is to be applied to the battery tray 2, the controller 13 controls the displacement generation unit 112 to drive the mounting base 110 to slide away from the battery tray 2 to ensure that the mounting base 110 is engaged with the other end of the pair of locking arms 120; in response to that the formation process of the batteries is finished, the controller 13 controls the mounting base 110 to slide close to the battery tray 2 to ensure that the mounting base 110 is detached from the pair of locking arms 120.

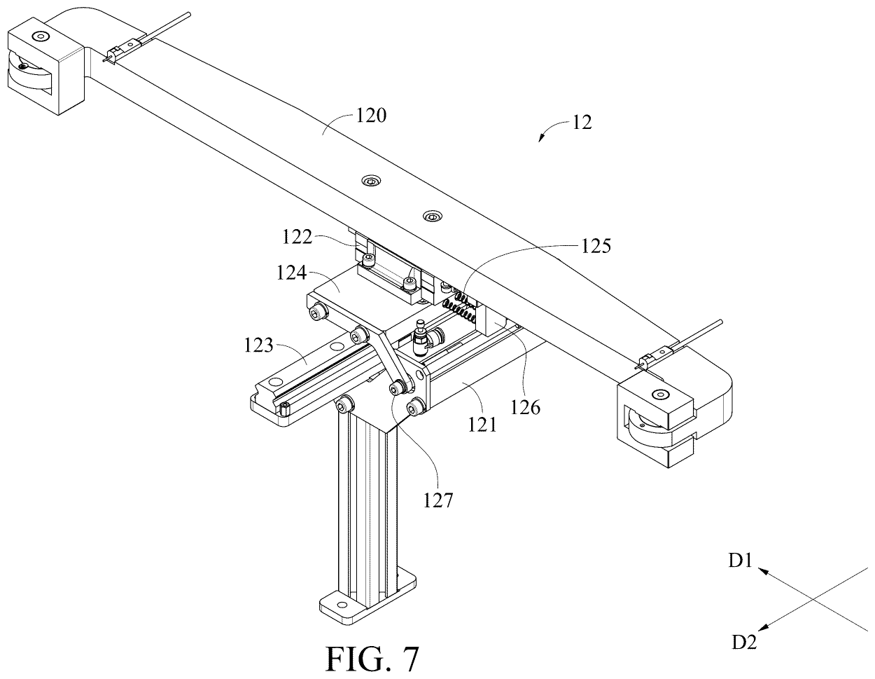

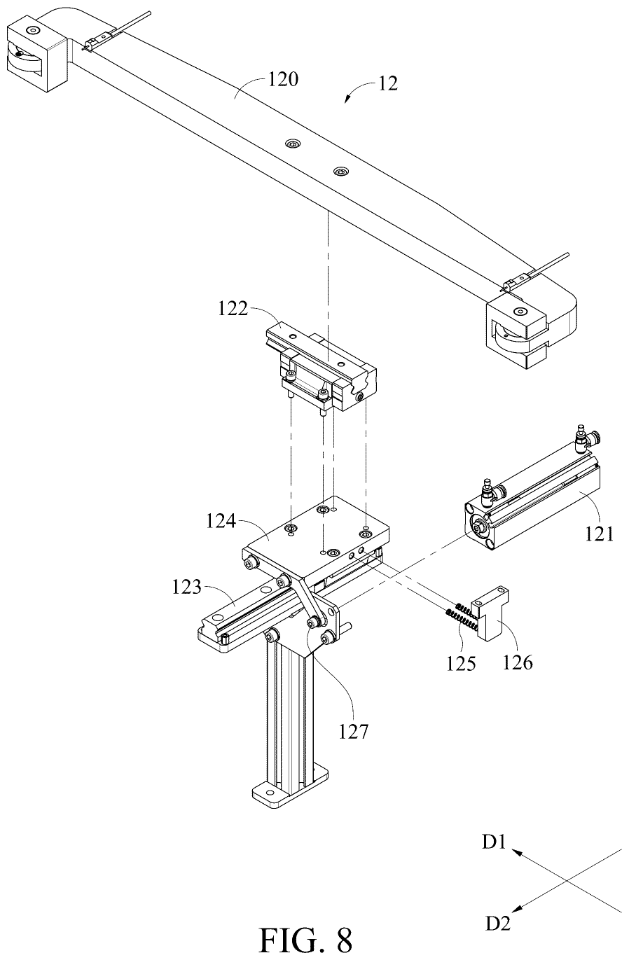

As shown in FIG. 7 and FIG. 8, the fixing module 12 further comprises a bearing plate 124 and an elastic member 125, and the bearing plate 124 is arranged between the first sliding member 122 and the second sliding member 123. In some embodiments, each of the pair of actuators 121 comprises a moveable portion 127, and each of the pair of locking arms 120 comprises a stopping portion 126. The moveable portion 127 is coupled to the bearing plate 124, and the elastic member 125 is arranged between the bearing plate 124 and the stopping portion 126. Accordingly, through the configuration of the elastic member 125, in response to that the operation of the pressurizing apparatus 1 for the battery tray 2 is stopped, the pair of locking arms 120 can be ensured to move to an initial position resiliently; that is, the pair of locking arms 120 are moved resiliently along the first direction D1. Therefore, in some embodiments, the pair of actuators 121 in the first direction D1 can be omitted.

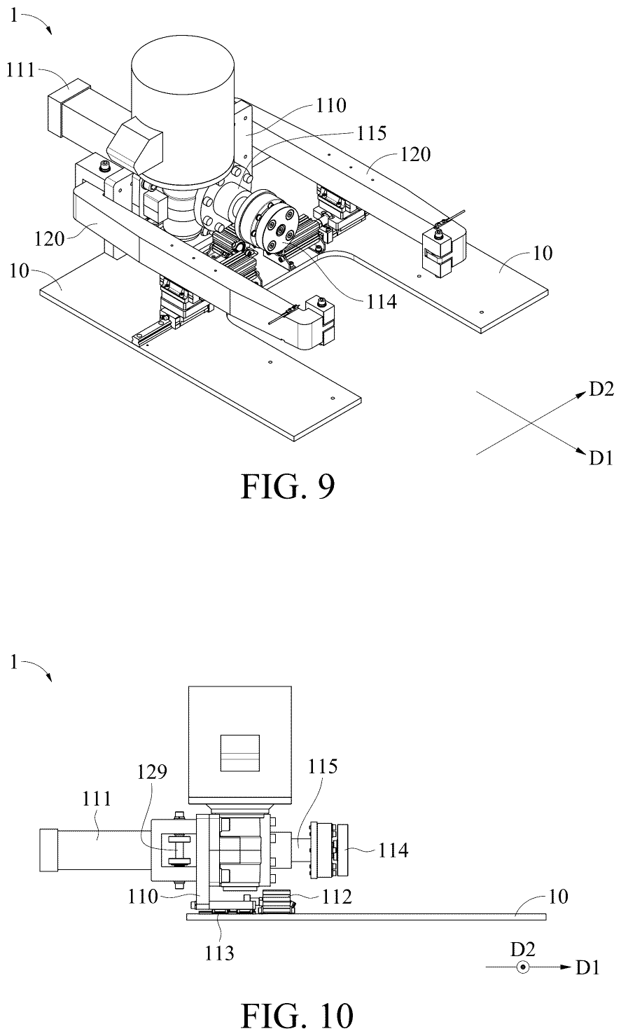

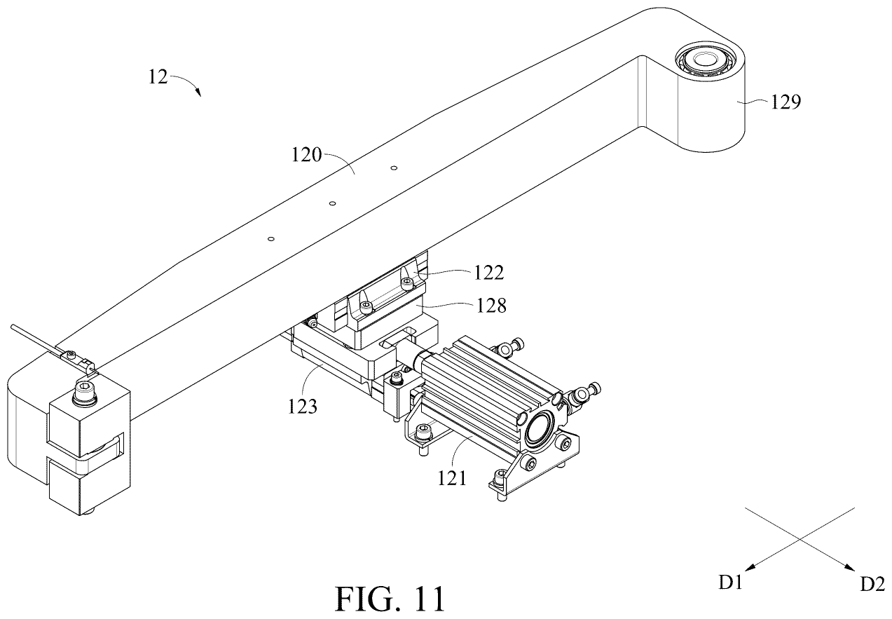

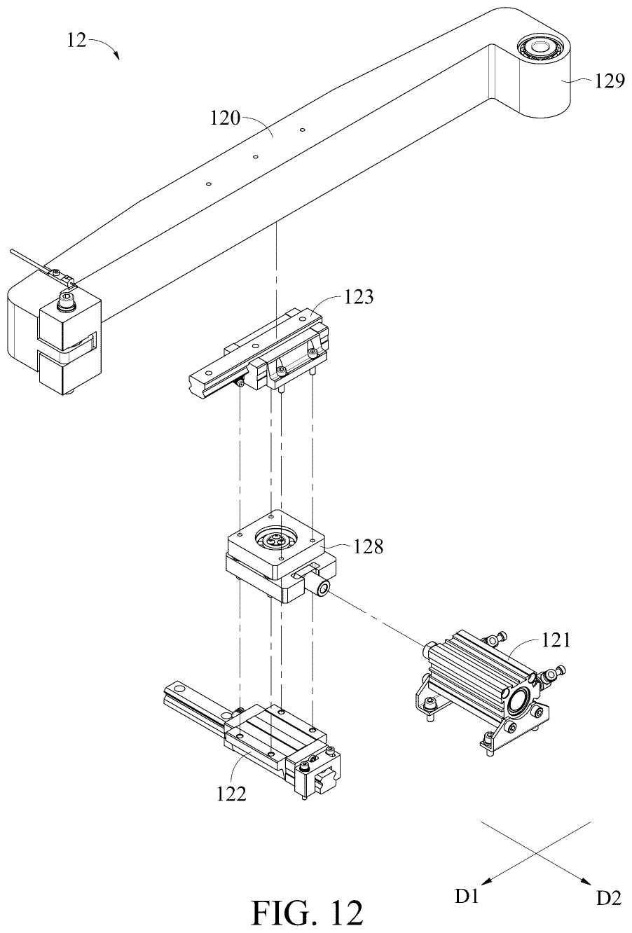

Please refer to FIG. 1 to FIG. 4 and FIG. 9 to FIG. 12, in which FIG. 9 to FIG. 12 illustrate implementations of a second embodiment of the pressurizing apparatus 1 for the battery tray 2. One of the differences between the second embodiment and the first embodiment is and the configuration and the arrangement of the fixing module 12. Specifically, as shown in FIG. 9 to FIG. 12, the pair of actuators 121 are arranged on the base 10 and electrically connected to the controller 13. The pair of locking arms 120 are arranged on the first sliding member 122, and the second sliding member 123 is arranged between the first sliding member 122 and the base 10 and coupled to the pair of actuators 121.

In some embodiments, the fixing module 12 further comprises a pivoting member 128, which may be a ball bearing arranged between the first sliding member 122 and the second sliding member 123. Therefore, the first sliding member 122 and the second sliding member 123 are pivotally rotated with respect to each other through the pivoting member 128. In addition, one of two ends of the pair of locking arms 120 is hinged to the mounting base 110 through a hinge member 129, which may also be a ball bearing. Therefore, in some embodiments, in response to that the controller 13 controls the pair of actuators 121 to drive the pair of locking arms 120 to move, only the end of the locking arm 120 far away from the mounting base 110 can move close to or away from the fixing plate 200; that is, each of the pair of locking arms 120 performs a swinging motion. At this moment, the pair of locking arms 120 can slide along the first direction D1 through the first sliding member 122 and slide along the second direction D2 through the second sliding member 123. In addition, the configuration of the pivoting member 128 and the hinge member 129 allows the pair of locking arms 120 to be rotated during the swinging motion of the pair of locking arms 120.

In the present embodiment, before the pressurizing apparatus 1 for the battery tray 2 applies the compressive force to the battery tray 2, one of two ends of the pair of locking arms 120 is engaged with the fixing plate 200 of the battery tray 2 to ensure that the distance between the compressive force generation module 11 and the battery tray 2 is maintained within a specific range. The subsequent pressurizing processes are similar to the first embodiment mentioned above and will not be described in detail.

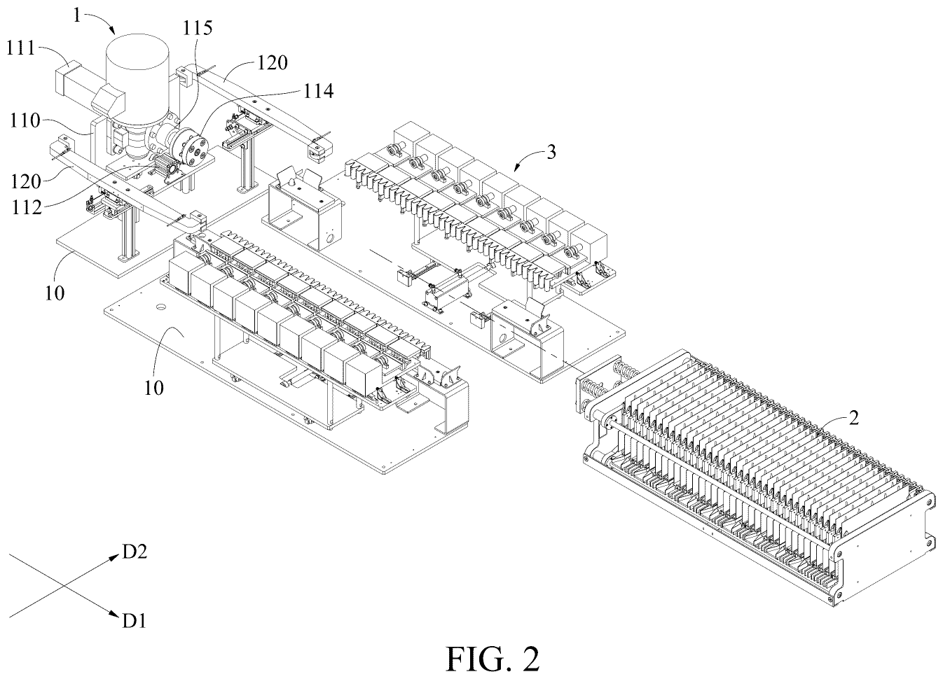

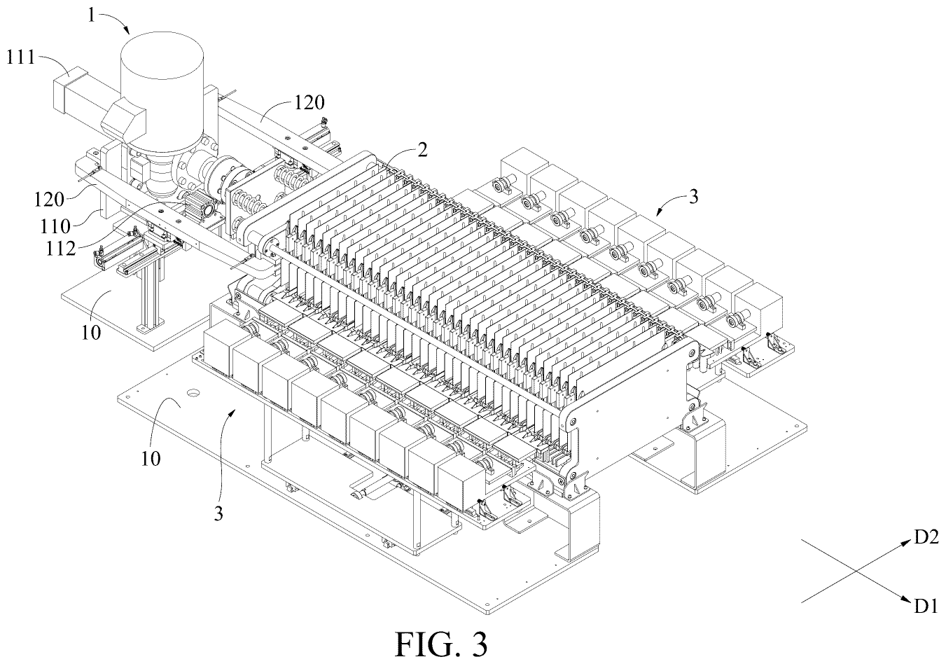

As shown in FIG. 2, FIG. 3, and FIG. 4, in some embodiments, a pair of spacing maintenance devices 3 is arranged on two sides of the battery tray 2. In response to that the battery tray 2 moves to a pressurizing position, the pair of spacing maintenance devices 3 move close to the battery tray 2. In some embodiments, the pair of spacing maintenance devices 3 are configured to maintain the distance between the two adjacent partition plates 23 on the battery tray 2 and supply power for the batteries (not shown) to perform the formation process.

In some embodiments, the thrust generator 111 may be a screw jack reducer, a hydraulic cylinder, a pneumatic cylinder, an electric cylinder, or a linear motor, while the present disclosure is not limited thereto. In some embodiments, the pressurizing head 114 has a plurality of magnets 4 (as shown in FIG. 5), and the pressure-bearing plate 22 of the battery tray 2 is made of magnetic materials. In some embodiments, in response to that the formation process of the batteries is finished, the pressurizing head 114 moves away from the battery tray 2. At this moment, the pressurizing head 114 can attach the pressure-bearing plate 22 through the plurality of magnets 4 to make the battery tray 2 close to the mounting base 110, and the fixing plate 200 of the battery tray 2 can be detached from the pair of locking arms 120 to make the pair of locking arms 120 smoothly move to the initial position resiliently.

In some embodiments, the controller 13 may be a hardware element which has a control function, such as but not limited to a central processing unit (CPU), a microprocessor, a digital signal processor (DSP), a complex programmable logic device (CPLD), a field programmable gate array (FPGA), an application specific integrated circuit (ASIC), or a microcontroller unit (MCU). In addition, the controller 13 may be any single or multiple processor computing devices/systems that execute computer readable instructions, such as but not limited to a workstation, a laptop computer, a client terminal, a server, a distributed computing system, a handheld device, or any other computing systems/devices. In a basic configuration, the controller 13 may include at least one processor and system memory.

In some embodiments, each of the pair of actuators 121 may be a pneumatic cylinder, an electric cylinder, or a linear motor; the first sliding member 122 and the second sliding member 123 may respectively be a guide device which has a sliding function, such as but not limited to a linear sliding rail, a ball screw, a linear bearing, an air levitation system, or a magnetic levitation system.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A pressurizing apparatus for a battery tray, wherein the battery tray comprises a frame, a pressurizing plate, a pressure-bearing plate, a plurality of partition plates, and at least one spring, the pressurizing plate, the pressure-bearing plate, and the plurality of partition plates are coupled to the frame, the at least one spring is arranged between the pressurizing plate and the pressure-bearing plate, and at least one battery is arranged on each of the plurality of partition plates, and wherein the pressurizing apparatus comprises:
a base;
a compressive force generation module arranged on the base;
a fixing module arranged on the base; and
a controller electrically connected to the compressive force generation module and the fixing module, wherein the controller is configured to control the fixing module to be coupled between the compressive force generation module and the frame of the battery tray, and the controller is configured to control the compressive force generation module to apply a compressive force to the pressure-bearing plate of the battery tray so that the pressure-bearing plate presses the pressurizing plate through the at least one spring, thereby forming a containment on the at least one battery on each of the plurality of partition plates.

2. The pressurizing apparatus for the battery tray according to claim 1, wherein the compressive force generation module comprises:
a mounting base coupled to the base; and
a thrust generator arranged on the mounting base;
wherein the frame comprises a fixing plate, the fixing plate comprises at least one locking arm;
wherein in response to that the controller controls the fixing module to be coupled between the compressive force generation module and the frame, one of two ends of the at least one locking arm is engaged with the mounting base, and the other end of the at least one locking arm is engaged with the fixing plate.

3. The pressurizing apparatus for the battery tray according to claim 2, wherein the compressive force generation module further comprises:
a displacement generation unit arranged on the base; and
a guide rail arranged on the base;
wherein, the mounting base is coupled to the guide rail, and the displacement generation unit is electrically connected to the controller and is controlled to drive the mounting base to slide.

4. The pressurizing apparatus for the battery tray according to claim 2, wherein the fixing module further comprises an actuator, the actuator is coupled to the base and electrically connected to the controller;
wherein the at least one locking arm is coupled to the actuator, and the controller is further configured to control the actuator to make the at least one locking arm move close to or away from the mounting base and the fixing plate.

5. The pressurizing apparatus for the battery tray according to claim 4, wherein the fixing module further comprises:
a first sliding member coupled to the at least one locking arm, wherein the at least one locking arm slides along a first direction through the first sliding member; and
a second sliding member arranged between the first sliding member and the base and coupled to the actuator, wherein the at least one locking arm slides along a second direction through the second sliding member.

6. The pressurizing apparatus for the battery tray according to claim 5, wherein the at least one locking arm comprises a stopping portion, the fixing module further comprises:
a bearing plate arranged between the first sliding member and the second sliding member, wherein the actuator comprises a moveable portion, and the moveable portion is coupled to the bearing plate; and
an elastic member arranged between the bearing plate and the stopping portion.

7. The pressurizing apparatus for the battery tray according to claim 1, wherein the compressive force generation module comprises:
a mounting base arranged on the base; and
a thrust generator arranged on the mounting base;
wherein the frame comprises a fixing plate, the fixing plate comprises at least one locking arm, and one of two ends of the at least one locking arm is hinged with the mounting base; and
wherein in response to that the controller controls the fixing module to be coupled between the compressive force generation module and the frame, the other end of the at least one locking arm is engaged with the fixing plate.

8. The pressurizing apparatus for the battery tray according to claim 7, wherein the fixing module further comprises:
an actuator arranged on the base and electrically connected to the controller;
a first sliding member coupled to the at least one locking arm; and
a second sliding member arranged between the first sliding member and the base and coupled to the actuator;
wherein in response to that the controller controls the actuator to drive the other end of the at least one locking arm to move close to or away from the mounting base and the fixing plate, the at least one locking arm slides along a first direction through the first sliding member, and the at least one locking arm slides along a second direction through the second sliding member.

9. The pressurizing apparatus for the battery tray according to claim 8, wherein the fixing module further comprises a pivoting member, the pivoting member is arranged between the first sliding member and the second sliding member, and the first sliding member and the second sliding member are pivotally rotated with respect to each other through the pivoting member.

10. A pressurizing apparatus for a battery tray comprising:
a base;
a compressive force generation module comprising a thrust generator and a mounting base, wherein the mounting base is coupled to the base, and the thrust generator is arranged on the mounting base;
a fixing module comprising a pair of actuators and a pair of locking arms, wherein the pair of actuators are arranged on the base, and the pair of locking arms are respectively coupled to the pair of actuators and arranged on two side of the compressive force generation module and two side of the battery tray; and
a controller electrically connected to the thrust generator and the pair of actuators, wherein the controller is configured to control the pair of actuators to drive the pair of locking arms to be respectively coupled between mounting base and the battery tray, thereby maintaining a distance between the compressive force generation module and the battery tray within a specific range, and the controller is configured to control the thrust generator to apply a compressive force to the battery tray.
